(19) United States
(12) Patent Application Publication
(10) Pub. No.: US 2004/0238648 A1
(43) Pub. Date: Dec. 2, 2004

(54) Contactless communication device applicable to a wristwatch

(76) Inventor: Leo Chen, Hong Kong (CN)

Correspondence Address: Weighman Lee, 1B-4B, 2/FL., Hoplite Ind. Center,, No. 3-5 Wang Tai Road, Kowloon Bay, Hong Kong, CN

(21) Appl. No.: 10/857,146

(22) Filed: Jun. 1, 2004

(30) Foreign Application Priority Data
May 30, 2003 (CN) 03246842.3

(51) Int. Cl. G06K 19/06

(52) U.S. Cl. 235/492

(57) ABSTRACT

A contactless communication device applicable to a wristwatch comprises a contactless IC, an induction antenna coil, a housing and a fixing device for fixing said contactless communication device applicable to a wristwatch on the wristband of a watch. Said housing can be comprising a case body and a supporter. The present invention can be fixed on different wristbands of different watches so that people can reach to contactless electronic data communicate while change their watch.

### BACKGROUND OF THE INVENTION

This present invention relates to a device applying the technology of contactless IC card, especially to a device with a contactless communication function as a contactless IC card which can be applied to a wristwatch.

As an electronic data communication product, a conventional contactless IC card provides people with convenience of being used as a ticket in bus stations, subways, clubs, restaurants, ball clubs, parks, etc. With a contactless IC chip and an induction antenna coil installed inside, the contactless IC card is enveloped and shaped by plastic cards. The IC chip is preprogrammed with relative programs and prepaid value data. While the. contactless IC card is used, it can communicate with a relative card reader or an automatic ticket machine without directly touching. However, an IC card can be easily lost and spoiled, it is not convenient to be carried and apt to being broken. It is very troublesome for people to put their IC card in pocket or wallet and take it out when they need to use it. Therefore, people desire they could have a contactless communicating product with good quality and easy to be carried and kept.

By the way, for people like wearing a watch, a contactless IC and an induction antenna coil can be installed in a watch with its structure changed. What is more, once a contactless IC and an induction antenna coil are installed in a watch, they could not be taken out of the particular watch. So, contactless communication can't be realized when people change the watch.

### BRIEF SUMMARY OF THE INVENTION

The object of the present invention is to provide a contactless communication device applicable to a wristwatch, which can be fixed on the wristband of a watch.

The present invention comprises a housing, a contactless IC and an induction antenna coil both of which are installed inside said housing, and a fixing device for fixing said contactless communication device applicable to a wristwatch on the wristband of a watch. The contactless IC and the induction antenna coil have the wireless and contactless communicating function as the conventional products. Said housing comprises a case body and a supporter where said supporter is connected with said case body. Said fixing device can be applied by a fixing band.

That is to say, using the technology of contactless IC card, the contactless IC and the induction antenna coil are installed in the supporter. The supporter connects with the case body. The whole housing case becomes an airtight case structure that can protect the contactless IC and the induction antenna coil installed inside.

Each end of the fixing band has an open hole wherein inserted a spring bar whose two ends protrude out of the open hole. Each of the two opposite sides of the case body has a notch. Each notch has two opposite holes for fixing the spring bar. The spring bar inserted in the open holes of the fixing band can wedge in between the two opposite holes of the notch, then, the fixing band is fixed on the case body.

The present invention has the following advantages: as a device applying the similar technology of contemporary contactless IC card, the present invention can be applied to and fixed on the wristband of a watch. So it can not be lost easily. It has a small and light body. Comparing with the conventional IC card, the present invention is a more practical, exquisite one. As an accessory of a watch, the present invention can be fixed on different wristbands of different watches so that people can still accomplish contactless communication while changing their watch.

### BRIEF DESCRIPTION OF THE DRAWINGS

FIG. 1 is a top view according to a first embodiment of the present invention;

FIG. 2 is a cross sectional view of direction b-b of FIG. 1;

FIG. 3 is a cross sectional view according to the first embodiment of the present invention;

FIG. 4 is a perspective view of the fixing band with spring bar according to the first embodiment of the present invention;

FIG. 5 is a perspective view of the bottom of the supporter according to a second embodiment of the present invention;

FIG. 6 is a schematic view of the present invention when fixing on the wristband of a watch.

### DETAILED DESCRIPTION OF THE INVENTION

Embodiments of the present invention are described below with reference to the drawings.

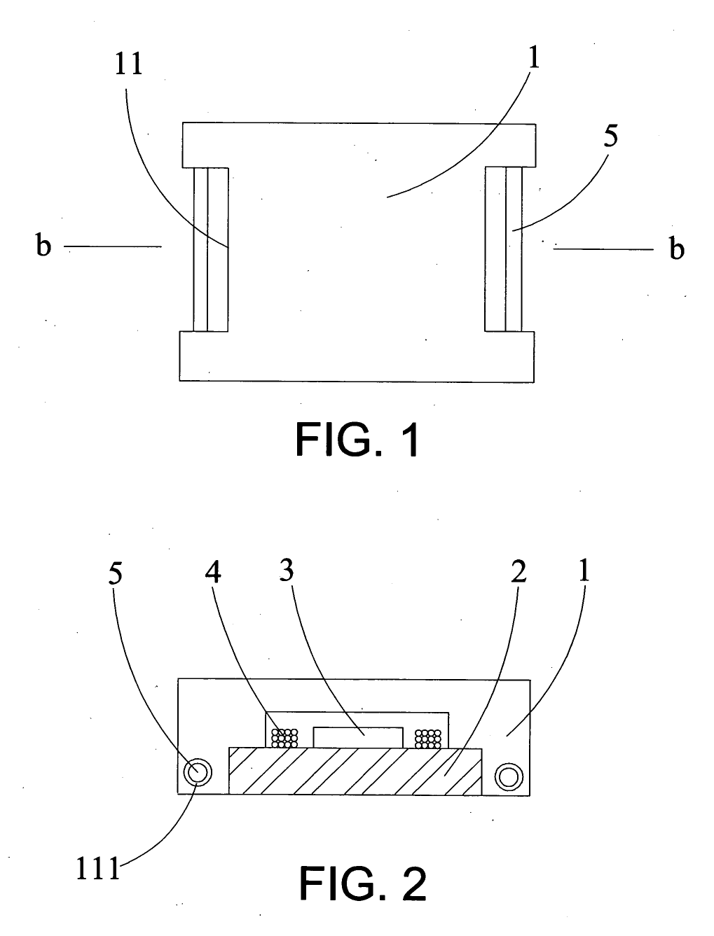

As shown in FIG. 1, there are notches 11 in two opposite sides of the case body 1. A spring bar 5 is fixed between the two opposite inner sides of the notch 11. In this embodiment, the case body 1 covers the supporter, so the supporter could not be seen in FIG. 1. The spring bar 5 is fixed between the holes of the two opposite sides of the notch 11, thus we could not see such holes in FIG. 1.

As shown in FIG. 2, the present invention comprises a contactless IC 3 and an induction antenna coil 4, a case body 1 and a supporter 2 for fixing the contactless IC 3 and the induction antenna coil 4. The case body 1 connects with the supporter 2. The notch 11 of the case body 1 has holes 111 for fixing the spring bar 5, the spring bar 5 is faxed between the two opposite holes 111. The working principle of the contactless IC 3 and the induction antenna coil 4 is the same as conventional technology of contactless IC card. Simply speaking, the contactless IC 3 has connecting points for connecting with the corresponding ends of the induction antenna coil 4. We can fulfill the electronic data communication by placing the present invention towards an external contactless terminal unit such as a card reader. The case body 1 and the supporter 2 are preferably made of plastic and they can be joined by glue. They also can be joined airtight by using an ultrasonic plastic soldering machine, where the ultrasonic soldering machine produces heat to fuse their connecting parts together.

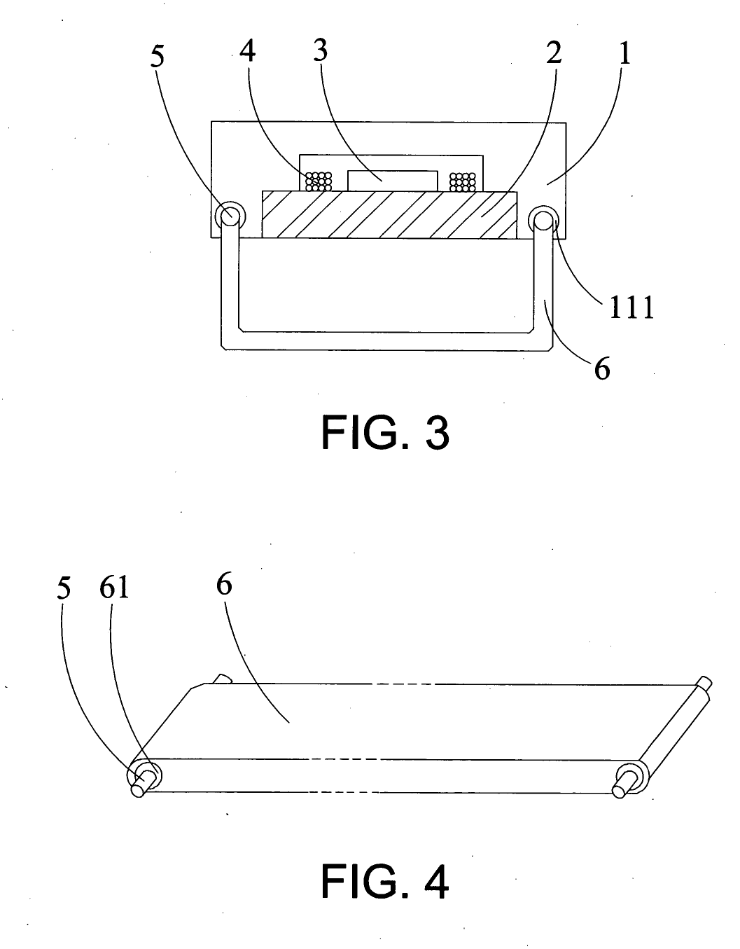

FIG. 3 is a perspective view according to the first embodiment of the present invention. The present invention comprises the case body 1, the supporter 2, the contactless IC 3, the induction antenna coil 4 and a fixing band 6 used as the fixing device. The fixing band 6 is fixed on the case body 1 by the spring bar 5. The present invention can be fixed on the wristband by its fixing band 6 wrapping the wristband of a watch. Then, the watch is of contactless communication function of a contactless IC card. Of course, the fixing band 6 of this embodiment is also a disconnectable device. Take out the spring bar 5 from the two opposite holes 111, the fixing band 6 can be taken off. Thus the present invention can be fixed on different watches.

FIG. 4 is a perspective view of the fixing band 6 of the first embodiment of the present invention. Each end of the fixing band 6 has a hole 61 for inserting the spring bar 5. The two ends of the spring bar 5 protrude out from the hole 61. Combining FIG. 3 with FIG. 4, after the spring bar 5 inserts into the fixing band 6, the fixing band 6 can be further fixed in holes 111 of case body 1. That is to say, the two ends of the spring bar 5 are inserted into the two opposite holes 111.

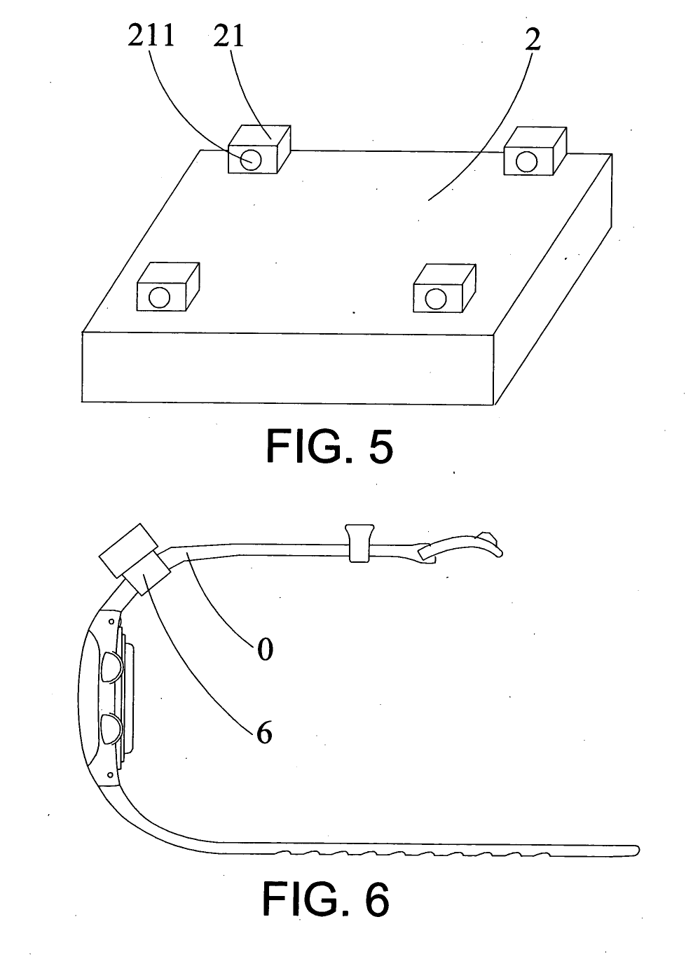

FIG. 5 shows the supporter of a second embodiment according to the present invention. In FIG. 5, the case body is upended. The second embodiment is almost the same as the first embodiment. The only difference between the two embodiments is the position to fix the fixing band. In the second embodiment, the fixing band is fixed on the supporter 2. Concretely speaking, two pairs of opposite projections 21 are built on the bottom of the supporter 2. Each projection 21 has a hole 211. After the spring bars insert into the fixing band, each spring bar wedges in between the two opposite holes 211 of each pair of projections 21. Therefore, the fixing band is fixed on the supporter 2.

As shown in FIG. 6, the present invention can be fixed on the wristband 0, so, the watch is of contactless communication function. The fixing device 6 of a watch can fix the contactless communication device applicable to a wristwatch onto the wristband 0. The fixing device 6 connects to the case body or the supporter. The fixing device 6 can be the fixing band of the first embodiment or the second embodiment, and a device integratedly injected with said case body or with said supporter, with which the bottom side of said supporter used for wrapping and fastening the wristband 0.

The fixing band can be an elastic band. The form, material, fixing position and fixing method of the fixing device could not limit the protecting extension of the present invention. The key points of the present invention are: it is a device with a contactless communication function and a fixing device; it can be an accessory of watch; it can be fixed on the wristband of a watch, thus the watch can have the contactless IC card function without changing its structure.

What is claimed is:

1. A contactless communication device applicable to a wristwatch, comprising:
a housing; a contactless IC and an induction antenna coil both of which are installed inside said housing; a fixing device for fixing said contactless communication device applicable to a wristwatch on the wristband of a watch.

2. A contactless communication device applicable to a wristwatch according to claim 1, wherein said housing comprises a case body and a supporter which connects said case body.

3. A contactless communication device applicable to a wristwatch according to claim 1 or claim 2, wherein said contactless IC and said induction antenna coil are installed on said supporter.

4. A contactless communication device applicable to a wristwatch according to claim 1, wherein said fixing device is a fixing band of which each end has an open hole.

5. A contactless communication device applicable to a wristwatch according to claim 4, wherein a spring bar is inserted in said open hole and the two ends of said spring bar protrude out of said open hole.

6. A contactless communication device applicable to a wristwatch according to claim 2, wherein each of the two opposite sides of said case body has a notch.

7. A contactless communication device applicable to a wristwatch according to claim 6, wherein each of the two sides of said notch has a fixing hole used for fixing said spring bar.

8. A contactless communication device applicable to a wristwatch according to any claim of claim 1, claim 2, claim 4, claim 5 or claim 6, wherein said spring bars which are inserted in said open holes of said fixing band wedge in between two opposite said fixing holes of said notches in said case body's sides.

9. A contactless communication device applicable to a wristwatch according to claim 2, wherein said supporter has two pairs of opposite projections, each of said projection has one hole.

10. A contactless communication device applicable to a wristwatch according to any claim of claim 1, claim 2, claim 4, claim 5 or claim 9, wherein said spring bars which are inserted in said open holes of said fixing band wedge in between said holes of two opposite said projections on the bottom of said supporter.

11. A contactless communication device applicable to a wristwatch according to claim 1 or claim 2, wherein said fixing device is a device integratedly injected with said case body, with which the bottom side of said supporter together are used for wrapping and fastening the wristband of a watch.

12. A contactless communication device applicable to a wristwatch according to claim 1 or claim 2, wherein said fixing device is a device integratedly injected with said supporter, with which the bottom side of said supporter are used for wrapping and fastening the wristband of a watch.
